(19) United States
(12) Patent Application Publication
(10) Pub. No.: US 2024/0223117 A1
(43) Pub. Date: Jul. 4, 2024

(54) Discontinuous Adaptive Pulse Width Modulation for Three-Phase Voltage Source Inverters

(71) Applicant: Karma Automotive LLC, Irvine, CA (US)

(72) Inventors: Robert Dziuba, Irvine, CA (US); Sina Hamzehlouia, Irvine, CA (US); Fazel Farahmand, Aliso Viejo, CA (US)

(73) Assignee: Karma Automotive LLC, Irvine, CA (US)

(21) Appl. No.: 18/158,052

(22) Filed: Jan. 23, 2023

Related U.S. Application Data
(60) Provisional application No. 63/478,018, filed on Dec. 30, 2022.

(51) Int. Cl. H02P 27/08; B60L 15/02; B60L 15/20; H02P 23/14

(52) U.S. Cl. CPC H02P 27/08; B60L 15/02; B60L 15/20; H02P 23/14

(57) ABSTRACT

A method for reducing switching losses while an inverter performs discontinuous pulse width modulation includes receiving rotor angle measurements of an electric motor and generating, using the rotor angle measurements of the electric motor, a three-phase output. The method also includes receiving system state information of the vehicle, determining an angle shift based on the system state information of the vehicle, and determining a plurality of control signals based on the three-phase output and the angle shift. Each respective control signal of the plurality of control signals corresponds to a respective switch among a plurality of switches of the inverter. The method also includes instructing the plurality of switches of the inverter to control operation of the electric motor based on the plurality of controls signals.

### CROSS-REFERENCE TO RELATED APPLICATIONS

This U.S. patent application claims priority under 35 U.S.C. § 119(e) to U.S. Provisional Application 63/478,018, filed on Dec. 30, 2022. The disclosure of this prior application is considered part of the disclosure of this application and is hereby incorporated by reference in its entirety.

### TECHNICAL FIELD

This disclosure relates to discontinuous adaptive pulse width modulation for three-phase voltage source inverters.

### BACKGROUND

Electric motors are controlled using power from an energy storage device (e.g., battery), in which an inverter converts direct current (DC) power stored in the energy storage device into three-phase alternating current (AC) power to operate the electric motor. The inverter includes a plurality of switching devices controlled in pulse width modulation (PWM) for generating AC power.

### SUMMARY

One aspect of the disclosure provides a computer-implemented method for reducing switching losses by an inverter performing discontinuous pulse width modulation (DWPM). The computer-implemented method is executed on data processing hardware that causes the data processing hardware to perform operations that include receiving rotor angle measurements of an electric motor implemented on a vehicle and generating, using the rotor angle measurements of the electric motor, a three-phase output. The operations also include receiving system state information of the vehicle, determining an angle shift based on the system state information of the vehicle, and determining a plurality of control signals based on the three-phase output and the angle shift. Here, each respective control signal of the plurality of control signals corresponds to a respective switch among a plurality of switches of the inverter. The operations also include instructing the plurality of switches of the inverter to control operation of the electric motor based on the plurality of controls signals.

Implementations of the disclosure may include one or more of the following optional features. In some implementations, instructing the plurality of switches of the inverter to control operation of the electric motor based on the plurality of controls signals includes instructing two of the plurality of switches to clamp to a direct current voltage input for a period of time. Here, a first one of the two of the plurality of switches instructed to clamp to the direct current voltage may clamp to one of a positive terminal or a negative terminal for a first half of the period of time and clamp to the other one of the positive terminal or the negative terminal for a second half of the period of time. Moreover, a second one of the two of the plurality of switches instructed to clamp to the direct current voltage may clamp to the positive terminal when the first one of the two of the plurality of switches is clamping to the negative terminal and may clamp to the negative terminal when the first one of the two of the plurality of switches is clamping to the positive terminal. In these implementations, the operations may include instructing other switches of the plurality of switches to modulate based on a pulse width modulation (PWM) signal while the two of the plurality of switches are instructed to clamp to the direct current voltage input for the period of time.

In some examples, the plurality of switches includes a first pair of switches corresponding to a first output node of the inverter, a second pair of switches corresponding to a second output node of the inverter, and a third pair of switches corresponding to a third output node of the inverter. Each switch of the plurality of switches may include a metal-oxide-semiconductor field-effect transistor (MOSFET). Alternatively, each switch of the plurality of switches comprises an insulate-gate bipolar transistor (IGBT).

In some implementations, the system state information of the electric vehicle includes at least one of a torque request, a brake request, a mass of the electric vehicle, a steering angle request, a global positioning system (GPS) signal of the electric vehicle. The operations may also include receiving current measurements of the electric motor. Here, the system state information may include the current measurements of the electric motor.

Another aspect of the present disclosure includes a vehicle. The vehicle includes data processing hardware and memory hardware in communication with the data processing hardware and storing instructions that when executed on the data processing hardware causes the data processing hardware to perform operations for reducing switching losses of an inverter while performing discontinuous pulse width modulation (DPWM). The operations include receiving rotor angle measurements of an electric motor implemented on a vehicle and generating, using the rotor angle measurements of the electric motor, a three-phase output. The operations also include receiving system state information of the vehicle, determining an angle shift based on the system state information of the vehicle, and determining a plurality of control signals based on the three-phase output and the angle shift. Here, each respective control signal of the plurality of control signals corresponds to a respective switch among a plurality of switches of the inverter. The operations also include instructing the plurality of switches of the inverter to control operation of the electric motor based on the plurality of controls signals.

This aspect of the disclosure may include one or more of the following optional features. In some implementations, instructing the plurality of switches of the inverter to control operation of the electric motor based on the plurality of controls signals includes instructing two of the plurality of switches to clamp to a direct current voltage input for a period of time. Here, a first one of the two of the plurality of switches instructed to clamp to the direct current voltage may clamp to one of a positive terminal or a negative terminal for a first half of the period of time and clamp to the other one of the positive terminal or the negative terminal for a second half of the period of time. Moreover, a second one of the two of the plurality of switches instructed to clamp to the direct current voltage may clamp to the positive terminal when the first one of the two of the plurality of switches is clamping to the negative terminal and may clamp to the negative terminal when the first one of the two of the plurality of switches is clamping to the positive terminal. In these implementations, the operations may include instructing other switches of the plurality of switches to modulate based on a pulse width modulation (PWM) signal while the two of the plurality of switches are instructed to clamp to the direct current voltage input for the period of time.

In some examples, the plurality of switches includes a first pair of switches corresponding to a first output node of the inverter, a second pair of switches corresponding to a second output node of the inverter, and a third pair of switches corresponding to a third output node of the inverter. Each switch of the plurality of switches may include a metal-oxide-semiconductor field-effect transistor (MOSFET). Alternatively, each switch of the plurality of switches comprises an insulate-gate bipolar transistor (IGBT).

In some implementations, the system state information of the electric vehicle includes at least one of a torque request, a brake request, a mass of the electric vehicle, a steering angle request, a global positioning system (GPS) signal of the electric vehicle. The operations may also include receiving current measurements of the electric motor. Here, the system state information may include the current measurements of the electric motor.

The details of one or more implementations of the disclosure are set forth in the accompanying drawings and the description below. Other aspects, features, and advantages will be apparent from the description and drawings, and from the claims

### DESCRIPTION OF DRAWINGS

FIG. 1 is a schematic view of an electric drive system including an energy storage device, a three-phase inverter, and an electric motor.

FIG. 2 is a schematic view of a circuit diagram for the three-phase inverter of the electric drive system of FIG. 1.

FIGS. 3A and 3B are schematic views of an example controller determining control signals for the three-phase inverter of FIG. 2 based on an angle shift.

FIG. 4 is a schematic view of a clamped space vector modulator based on the angle shift.

FIG. 5 is a schematic view of a clamped space vector modulator without using angle shift.

FIG. 6 is a schematic view of an example computing device that may be used to implement the systems and methods described herein.

Like reference symbols in the various drawings indicate like elements.

### DETAILED DESCRIPTION

Systems for controlling electric motors for electric vehicles usually include a power storage device (e.g., a battery), an inverter, one or more electric motors, and a controller. Here, the power storage device provides direct current (DC) power while the one or more electric motors require three-phase alternating current (AC) power for operation. Thus, the inverter converts the DC power provided by the power storage device into three-phase AC power thereby powering the one or more electric motors. In particular, the inverter includes a controller that instructs a switching state (e.g., open or closed) for each of a plurality of switches of the inverter (e.g., six (6) switches). Stated differently, the controller instructs the plurality of switches to open or close via pulse width modulation (PWM) control signals whereby AC power is output from the inverter. At any given time step, three (3) of the switches may be open while the other three (3) of the switches are closed. As such, the PWM control signals adjust the time (duty cycle) during which the switches are open and closed. The PWM control signals may include sinusoidal, chirp, or square waves. Thus, the inverter generates three separate AC power signals separated by one-hundred and twenty degrees phase angle to control the three-phase electric motors. However, switching the plurality of switches of the inverter results in switching losses thereby reducing the efficiency of the inverter.

Discontinuous pulse width modulation (DPWM) is a modulation technique for inverters driving electric motors whereby the inverter clamps two (2) of the six (6) switches to a positive terminal or a negative terminal of the DC bus voltage (e.g., the battery) while the inverter continues to modulate the other four (4) switches using PWM. As such, the AC power signals corresponding to the clamped switches are altered from the sinusoidal wave and are held at the constant value of either the positive battery terminal or the negative battery terminal during the clamping period. As used herein, clamping switches to the DC bus voltage is referred to as “clamping.” In three-phase DPWM, one phase (e.g., one switch) is always clamped to either the positive terminal or the negative terminal of the DC bus voltage. In some examples, the inverter clamps two (2) of the switches for one-third of a period of the PWM signal. As such, the inverter generates a third harmonics signal purposely to saturate PWM signals and reduce a number of switching events for the switches of the inverter while maintaining the same output phase-to-phase voltage values. As a result, the inverter may turn off switching on each phase (e.g., each pair of switches) for two (2) of eight (8) switching states. Although, in some examples, only six (6) of the eight (8) switching states are needed to produce AC power. However, clamping each phase arbitrarily or based on voltage does not optimally minimize the switching losses of the inverter.

Accordingly, implementations herein are directed towards methods and systems of controlling a three-phase inverter that opportunistically performs DPWM to drive electric motors. Stated differently, implementations herein determine an optimal time for clamping each phase of the inverter to minimize switching losses. Although implementations herein only contemplate controlling electric motors for electric vehicles, it is understood that this disclosure may apply equally to controlling electric motors for other applications. As will become apparent, the methods and systems described herein determine an adaptive (e.g., predictive) state of a system (e.g., electric vehicle) to determine an angle shift before switching is required such that the switching losses of the inverter are optimally minimized. Here, the state of the system may refer to any combinations of electric vehicle state information including, but not limited to, torque (e.g., acceleration request), brake request (e.g., deceleration request), mass of the electric vehicle, steering angle request (e.g., turning request), and/or global positioning system (GPS) signal of the electric vehicle.

The inverter receives DC power, as input, from a battery and includes six (6) switches that convert the DC power to AC power to control one or more electric motors. Thus, the state (e.g., open or closed) of each switch determines the output voltage of the inverter for driving the one or more electric motors. The inverter includes a controller that performs PWM to control the output voltage of the inverter by regulating the output voltage and current. That is, using PWM the controller adjusts the time (e.g., duty cycle) during which the switches are open and closed to provide the desired output voltage for the one or more electric motors. Moreover, the controller performs DPWM by clamping two (2) of the six (6) switches for a certain period of time while the controller actively modulates the other four (4) switches using PWM controls. As such, clamping refers to the period of time that two (2) of the switches remain either open (e.g., inactive) or closed (e.g., active) and are not actively modulated like the other four (4) switches. For instance, one of the two switches under clamping will always remain open (e.g., inactive) while the other one of the two switches is closed (e.g., active), and vice versa. The period of time that the two (2) switches are clamped includes one-third of a fundamental period of time which is the inverse of a fundamental frequency being proportional to the actual speed of the electric motor. For instance, an increase in fundamental frequency due to a proportional increase in speed of the electric motor will result in a decrease in the period of time that the two switches are clamped. Similarly, a decrease in fundamental frequency due to a proportional increase in speed of the electric motor will result in an increase in the period of time that the two switches are clamped. Moreover, clamping phase refers to a phase difference between a phase angle of the AC voltage output by the inverter and a phase angle of the clamping event.

Accordingly, the controller of the inverter calculates an angle shift when performing DPWM for use in opportunistically shifting a clamping phase of a clamping event to optimally minimize the switching losses of the inverter. This shifting of the clamping phase minimizes the switching loss of the inverter by clamping two (2) of the switches at an optimal time. In some examples, the inverter determines the angle shift based on a state of the system (e.g., electric vehicle) to clamp one of the three phases of the inverter. Additionally or alternatively, the inverter determines the angle shift based on a motor current of the electric motor reaching a maximum value and applying clamping at that time for the corresponding phase.

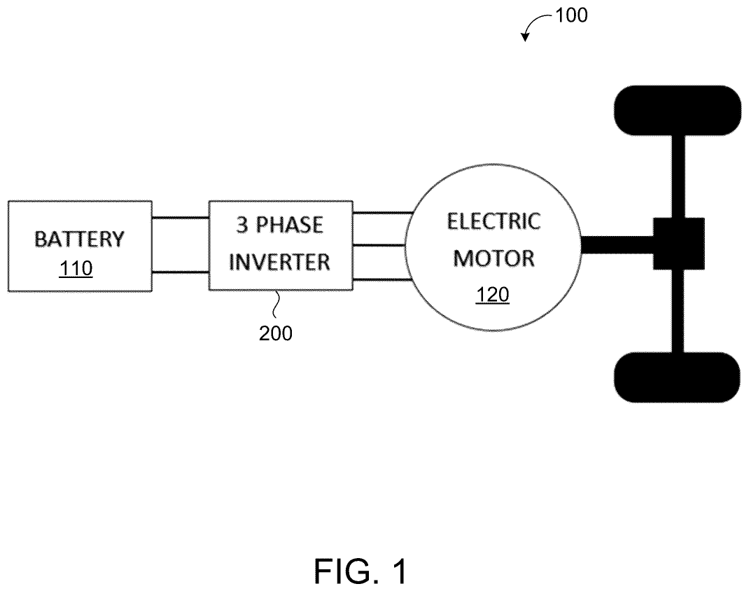

FIG. 1 shows an example electric drive system 100 of an electric vehicle. The example electric drive system 100 may correspond to any electric vehicle, for example, a battery electric vehicle (BEV), a hybrid electric vehicle (HEV), or a plug-in hybrid electric vehicle (PHEV). The electric drive system 100 includes one or more batteries (e.g., battery pack) 110 each storing energy that can be use used by the electric motors 120. The battery 110 provides a direct current (DC) voltage output and is electrically connected to a three-phase inverter 200 and one or more electric motors 120. For sake of clarity, FIG. 1 shows one battery 110 and one electric motor 120 only. However, it is understood the electric drive system 100 may include any number of batteries 110 and any number of electric motors 120 (e.g., one electric motor for each wheel of the electric vehicle).

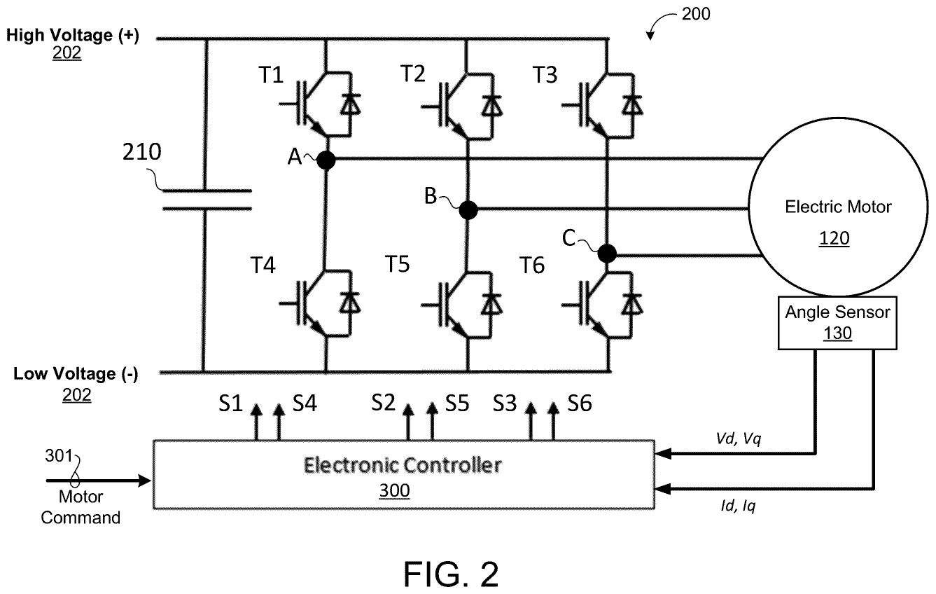

The three-phase inverter 200 (also referred to as simply “inverter 200”) is also electrically connected to the one or more electric motors 120 and is configured to transfer energy between the battery 110 and the electric motors 120. The electric motors 120 may require a three-phase alternating current (AC) output, and thus, the inverter 200 converts the DC voltage from the battery 110 to the three-phase AC output for the electric motors 120. The electric motors 120 may be configured to generate torque by receiving the three-phase AC output from the inverter 200 to drive wheels of the electric vehicle 130. The electric motors 120 may include rotational angle sensors 130 (FIG. 2) that detect the rotational position of a rotor of the electric motor 120 and continuously output the rotational position of the rotor.

The battery 110 may include a plurality of battery cells including a variety of chemical formulations. For example, battery cell chemical formulations may include, but are not limited to, lead acid, nickel cadmium (NiCd), nickel-metal hydride (NIMH), Lithium-Ion, or Lithium-Ion polymer. Each battery 110 may include a single battery cell or multiple battery cells electrically connected in parallel. On the other hand, each battery 110 may include a single battery cell or multiple battery cells connected in series, in parallel, or some combination thereof.

The battery 110 may include a battery controller that monitors and controls the performance of the battery 110. For instance, the battery controller may include a current sensor that measures the battery state of charge and capacity. The current sensor may utilize a variety of methods based on physical principles to detect the current including a Hall Effect integrated circuit (IC) sensor, a transformer or current clamp, a resistor in which the voltage is directly proportional to the current through it, fiber optics using an interferometer to measure the phase change in the light produced by a magnetic field, or a Rogowski coil. In the event a battery cell is charging or discharging such that the current entering or exiting the battery cell exceeds a threshold, the battery control module may disconnect the battery cell via the use of a circuit interrupt device (CID) such as a fuse or circuit breaker.

FIG. 2 is a circuit diagram of the 3-phase inverter 200 connected to the electric motor 120. The inverter 200 is electrically connected to a low voltage (−) node 202 (e.g., negative terminal of the battery 110 (FIG. 1)) and to a high voltage (+) node 204 (e.g., positive terminal of the battery 110 (FIG. 1)). The low voltage (−) node 202 shown in FIG. 2 represents a ground reference. The ground reference is not necessarily electrically connected to Earth. Instead, the ground reference represents a node that is maintained at a reference voltage that is substantially constant with respect to other voltages, which can be zero (0) volts or any non-zero voltage. The inverter 200 may also include a DC capacitor 210 connected in parallel to the high voltage (+) node 204 and the low voltage node (−) 202. The DC capacitor 210 is configured to generate an input voltage when charged by the battery 110 (FIG. 1). The input voltage of the DC capacitor 210 may be the input voltage of the inverter 200 that controls a plurality of switches T and drives the electric motor 120.

The inverter 200 includes a plurality of switches T (e.g., six (6) switches T1-T6). The plurality of switches may be a series of connected pairs of switches such as a first and fourth switch T1, T4, a second and fifth switch, T2, T5, and a third and sixth switch T3, T6. To avoid short circuiting, both switches T in the pairs of switches T cannot both be closed at the same time. As used herein, whether a respective switch is closed or open is referred to as a switch state of the respective switch T. Each switch T can be any power semiconductor switch, for example, a metal-oxide-semiconductor field-effect transistor (MOSFET) or an insulate-gate bipolar transistor (IGBT). Moreover, each switch T also includes a diode connected in parallel to provide reverse current flow.

The inverter 200 further includes a respective output node A-C for each corresponding pair of switches T. Here, each output node may interchangeably be referred to as an output leg of the inverter 200. As shown in FIG. 2, a first output node A corresponds to the pair of switches including the first and fourth switch T1, T4, a second output node B corresponds to the pair of switches including the second and fifth switch T2, T5, and a third output node C corresponds to the pair of switches including the third and sixth switches T3, T6. Each respective output node may be connected to either the high voltage (+) node 204 or the low voltage node (−) 202. For instance, when the first switch T1 is closed and the fourth switch T4 is open, the first output node A is connected to the high voltage (+) node 204. Alternatively, when the first switch T1 is open and the fourth switch T4 is closed, the first output node A is connected to the low voltage (−) node 202. As such, the output nodes A-C provide AC power signals to drive the electric motor 120, or provide the DC voltage from the battery 110, when the inverter 200 clamps the corresponding output node. During PWM control, each output node A-C includes AC power (e.g., sinusoidal signal) separated by one-hundred and twenty degrees phase angle from each other output node A-C.

The inverter 200 also includes a controller 300 configured to control the switch state of each switch of the plurality of switches T. More specifically, the controller 300 is electrically connected to each respective switch T and is configured to control the respective switch T with a corresponding control signal S. As shown in FIG. 2, a first control signal S1 is configured to control the switch state of the first switch T1, a second control signal S2 is configured to control the switch state of the second switch T2, a third control signal S3 is configured to control the switch state of the third switch T3, a fourth control signal S4 is configured to control the switch state of the fourth switch T4, a fifth control signal S5 is configured to control the switch state of the fifth switch T5, and a sixth control signal S6 is configured to control the switch state of the sixth switch T6. Thus, by outputting the controls signals S the controller 300 can control the switch state (e.g., closed or open) of each switch S and provide AC power to control the electric motor 120 via the output nodes A-C.

In some examples, the controller 300 receives a motor command signal 301 representing the desired operating state of the electric motor 120 for providing power to the electric vehicle 100 (FIG. 1). The controller 300 may use PWM to calculate the duty cycles (e.g., closed and open times) for the switches T. As will become apparent, in some implementations, the controller 300 uses discontinuous pulse width modulation (DPWM) to calculate the duty cycles for the switches T. In these implementations, DPWM improves the efficiency of the inverter 200 by reducing switching losses of the switches T by clamping two of the switches T of a respective phase at a time.

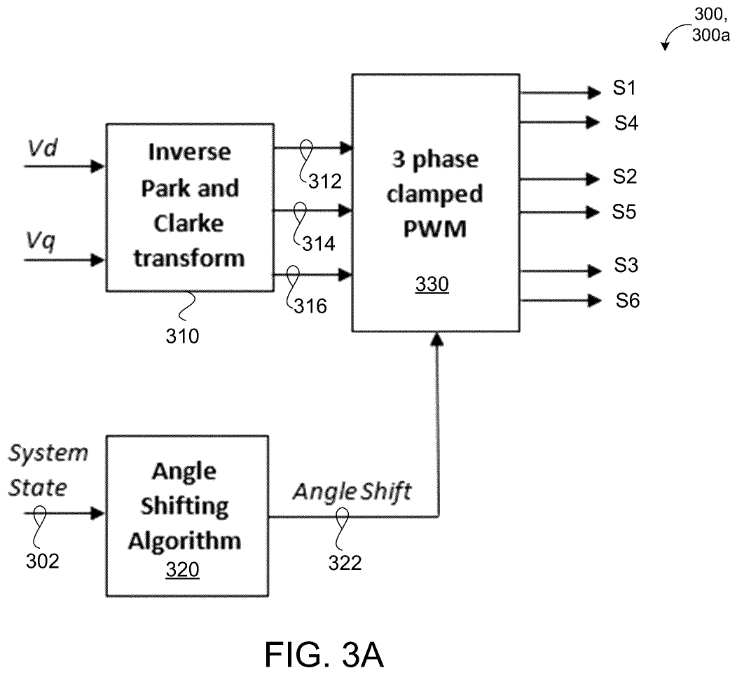

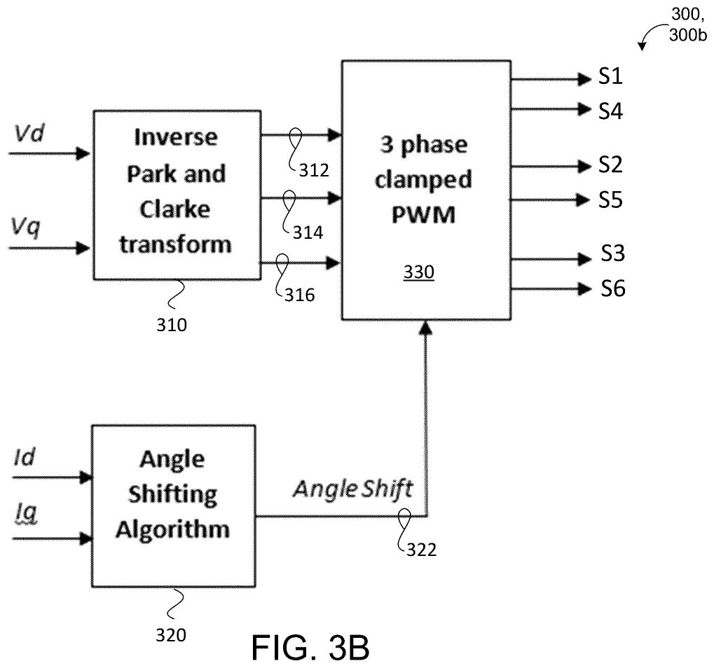

In some examples, the controller 300 receives torque related information of the electric motor 120 during operation thereof. That is, the controller 300 may receive rotor angle measurements Vd, Vq from an angle sensor 130 of the electric motor 120, whereby the rotor angle measurements Vd, Vq are represented as voltage values. As used herein, the rotor angle measurements may be interchangeably be referred to as voltage measurements Vd, Vq. Moreover, the controller 300 may optionally receive current measurements Id, Iq from the electric motor 120. Described in more detail with reference to FIGS. 3A and 3B, the controller 300 may generate the control signals S1-S6 based, in part, on the rotor angle measurements Vd, Vq and/or the current measurements Id (e.g., d-axis current), Iq (e.g., q-axis current) received from the electric motor 120. As described above, the controller 300 may clamp two (2) of the switches T for one-third of the period of the control signal S to reduce the switching losses. However, determining when to clamp the two (2) switches T in an adaptive and/or predictive manner will further reduce the switching losses.

Referring now to FIGS. 3A and 3B, the controller 300 includes a transformation module 310, an angle shift module 320, and a PWM module 330. In some examples, the controller 300 is configured to perform PWM whereby the controller 300 determines duty cycles (e.g., closed and open times) for each of the switches T of the inverter to adjust a torque of the electric motor to a desired value (e.g., motor command signal). In some implementations, the controller 300 performs DPWM whereby the controller 300 determines the duty cycles for each of the switches T. In these implementations, DPWM improves the efficiency of the inverter 200 (as compared to PWM) by reducing switching losses for the switches T of the inverter 200. Accordingly, the controller 300 may be configured to determine torque related information of the electric motor 120 during operation thereof based on a signal provided from the rotational angle sensor 130 and current values provided to the electric motor 120. To this end, the controller 300 is configured to operate the switches T1-T6 via the control signals S1-S6 so that the electric motor 120 operates according to the motor command signal 301 while simultaneously minimizing switching losses.

The transformation module 310 is configured to receive, at each time step, the rotor angle measurements Vd, Vq representing the rotor angle of the electric motor 120 at a corresponding time step, and generate a corresponding three-phase output 312, 314, 316. In some examples, the transformation module 310 applies an inverse Park transformation on the rotor angle measurements Vd, Vq to generate the corresponding three-phase output 312, 314, 316. Additionally or alternatively, the transformation module 310 may apply an inverse Clarke transformation on the rotor angle measurements Vd, Vq to generate the corresponding three-phase output 312, 314, 316. The PWM module (e.g., three-phase clamped PWM model 330) is configured to receive the three-phase output 312, 314, 316 generated by the transformation module 310 at the corresponding time step based on the rotor angle measurements Vd, Vq and generate, as output, the control signals S1-S6 based on the three-phase output 312, 314, 316 and an angle shift 322.

Referring now specifically to FIG. 3A, in some implementations, the angle shift module 320 of an example controller 300, 300a determines the angle shift 322 based on system state information 302 of the electric vehicle 100 (FIG. 1). Here, the system state information 302 of the electric vehicle 100 may include, without limitation, a torque request (e.g., acceleration request), brake request (e.g., deceleration request), mass of the electric vehicle, steering angle request (e.g., turning request), and/or a global positioning system (GPS) signal of the electric vehicle. For instance, an operator of the electric vehicle 100 may request torque by pressing an accelerator pedal, request braking by pressing the brake pedal, or request a steering angle by turning a steering wheel. Alternatively, an adaptive cruise control controller or an autonomous vehicle controller of the electric vehicle may make these requests without any interaction by the operator. The mass of the electric vehicle 100 may be known a priori based on a fixed value set by the manufacturer of the electric vehicle 100 and/or may be determined by load sensors of the electric vehicle 100. Moreover, the GPS signal may indicate a geographical location of the vehicle 100 that may be cross-referenced with mapping information to predict operating characteristics of the vehicle such as, for example, that the electric vehicle is approaching a turn, approaching an ascending grade of the road (e.g., uphill road), and/or approaching a descending grade of the road (e.g., downhill road). Cross-referencing the geographical location of the vehicle with mapping information may further allow predictions of upcoming torque or brake requests such as when the vehicle is approaching entry onto a highway (e.g., upcoming torque request to increase vehicle speed for highway speed limit) or when the vehicle is about to approach a stop sign, an intersection, and/or enter a zone with a reduced speed limit (e.g., upcoming brake request to reduce speed of the vehicle). Additionally, real-time or predicted traffic information may be further cross-referenced to ascertain information such as that the vehicle is approaching a congested area and will likely be reducing speed. Thus, the angle shift module 320 uses the system state information 302 to opportunistically adapt/predict operating conditions of electric motor 120 and thereby output the angle shift 322 to allow the PWM module 330 to opportunistically control when to apply clamping on respective pairs of the switches T. For example, based on the current speed and a GPS signal ascertained from system state information 302 indicating the vehicle 100 is approaching an ascending grade on the roadway, the angle shift module 320 may calculate a value for the angle shift 322 based on a determination that the electric vehicle 100 will require additional torque in order to maintain a current rate of speed while traveling on the ascending grade on the roadway. In response to receiving the angle shift 322, the PWM module 330 determines the corresponding control signals S1-S6 for opportunistically applying clamping during DPWM in order to minimize the switching losses.

Accordingly, the PWM module 330 is configured to receive, as input, the three-phase output 312, 314, 316 and the angle shift 322, and determine, as output, corresponding control signals S1-S6 that optimally apply clamping on respective pairs of switches T1/T4, T2/T5, T3/T6 in a manner that reduces switching losses compared to the conventional technique of applying DPWM that only relies on rotor angle measurements Vd, Vq of the electric motor 120 received as feedback. Advantageously, the PWM module 330 determine the control signals S1-S6 based, in part, on the angle shift 322 whereby the PWM module opportunistically (e.g., predictively) determines the control signals S1-S6 that will minimize the switching losses of the inverter 200 (FIG. 2). Simply put, without using the angle shift 322 to determine the control signals S1-S6, the PWM module 330 determines the control signals S1-S6 based only on the on rotor angle measurements Vd, Vq such that the PWM module 330 is unable to opportunistically or adaptively determine the control signals S1-S6 for clamping such that switching losses are not effectively minimized. Thus, the angle shift 322 determination based on the system state information 302 and received by the PWM module 330 indicates when to perform clamping on respective phases A-C of the inverter 200.

Referring now to FIG. 3B, in some implementations, the angle shift module 320 of an example controller 300, 300b determines the angle shift 322 based on the current measurements Id, Iq received from the electric motor 120a in addition to, or in lieu of, the system state information 302 used by the controller 300a of FIG. 3A. That is, based on scenarios when the current measurements Id, Iq lag the voltage measurements Vd, Vq, determining the controls signals S1-S6 (e.g., determining which switches to clamp) for applying DPWM based solely on the voltage measurements Vd, Vq of the rotor angle will not be optimal due to the lag of the current measurements Id, Iq. Stated differently, the current phase of the electric motor 120 indicated by the current measurements Id, Iq may be offset (e.g., lag) relative to the voltage phase applied to the electric motor 120. Accordingly, the angle shift module 320 of the controller 300b uses the current measurements Id, Iq to determine the angle shift 322 that accounts for the lag from the voltage measurements in order to cause the PWM module 330 to clamp the corresponding switches T of a respective phase of the inverter 200 once the current measurements Id, Iq match the voltage measurements of the rotor angle Vd, Vq. The system state information 302 of FIG. 3A may include the current measurements Id, Iq.

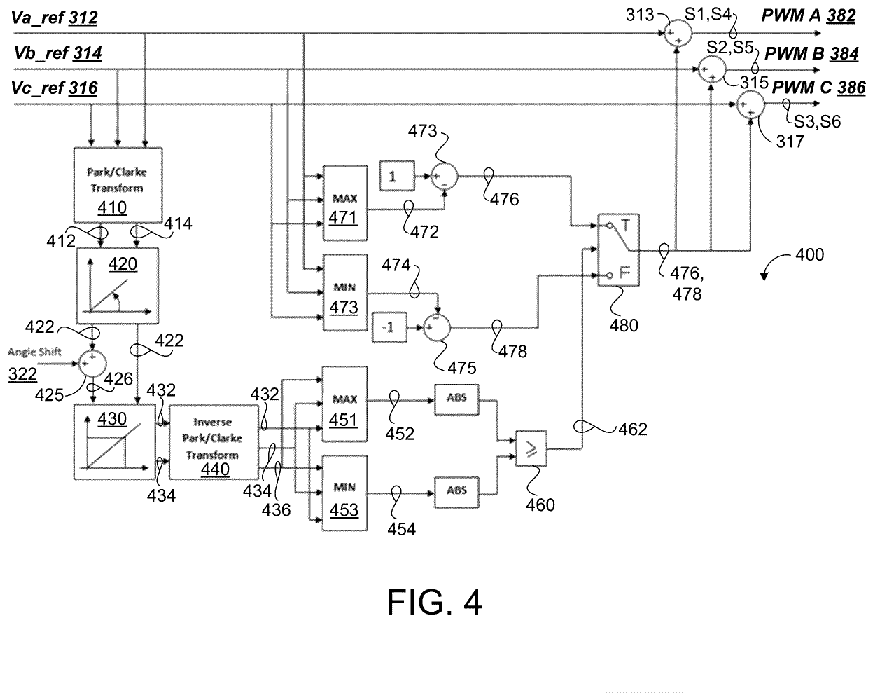

FIG. 4 shows a schematic view of an example clamped space vector modulator 400 using the angle shift 322 generated by the angle shift module 320 (FIGS. 3A and 3B) for controlling switch states of the plurality of switches T1-T6 while the inverter is performing DPWM. For instance, the clamped space vector modulator 400 may correspond to the PWM module 330 of the controllers 300 of FIGS. 3A and 3B. A first phase transform module 410 receives voltage reference signals Va 312, Vb 314, Vc 316 and generates a two-phase output 412, 414. In the example shown, the reference signals Va, Vb, Vc correspond to respective ones of the three-phase output 312, 314, 316, respectively. A first coordinate transform module 420 is configured to receive the two-phase output 412, 414 generated by the first phase transform module 410 and generate a corresponding polar coordinate output 422. Here, the first coordinate transform module 420 generates the polar coordinate output 422 by transforming the two-phase output 412, 414 from Cartesian to polar coordinates. Thereafter, an adder 425 adds the angle shift 322 generated by the angle shift module 320 (FIGS. 3A and 3B) to the polar coordinates 422 to generate angle shifted polar coordinates 426. A second coordinate transform module 430 may then receive the polar coordinates 422 output by the first coordinate transform module 420 and the angle shifted polar coordinates 426 corresponding to the polar coordinates 422 added to the angle shift 322 by the adder 425 and generates a corresponding Cartesian coordinate output 432, 434. Here, the second coordinate transform module 430 generates the Cartesian coordinate output 432, 434 by transforming the input polar coordinates 422, 426 to Cartesian coordinates.

A second phase transform module 440 receives the Cartesian coordinate output 432, 434 and generates a corresponding angle shifted three-phase output 432, 434, 436. Thus, the corresponding angle shifted three-phase output 432, 434, 436 generated by the second phase transform module 440 may correspond to the reference voltages Va 312, Vb 314, Vc 316 conditioned on the angle shift 322 generated by the angle shift module 320 (FIGS. 3A and 3B). A maximum operator 451 receives the angle shifted three-phase output 432, 434, 436 generated by the second phase transform module 440 and outputs a corresponding maximum value 452. Likewise, a minimum operator 453 receives the angle shifted three-phase output 432, 434, 436 generated by the second phase transform module 440 and outputs a corresponding minimum value 454. Absolute values of the maximum and minimum values 452, 454 are compared by a first conditional switch 460. The first conditional switch 460 is configured to output a value 462 equal to “true” when the absolute maximum value 452 and the absolute minimum value 454 are greater than or equal to one. Conversely, the first conditional switch 460 is configured to output the value 462 equal to “false” when the absolute maximum value 452 and the absolute minimum value 454 are less than one.

Another set of maximum and minimum operators 471, 473 are each configured to receive the reference voltages Va 312, Vb 314, Vc 316 (e.g., without adding the angle shift 322) and output corresponding maximum and minimum values 472, 474. In some examples, a subtractor 473 subtracts the maximum value 472 from one (1) to generate a first output value 476 and another subtractor 475 subtracts the minimum value 474 from negative one (−1) to generate a second output value 478. A second conditional switch 480 is configured to receive the value 462 from the first conditional switch 462 and output either the first output value 476 when the value 462 is equal to “true” or the second output value 478 when the value 462 is equal to “false”. A corresponding adder 313, 315, 317 associated with each reference signal Va 312, Vb 314, Vc 316 then adds the first output value 476 or the second output value 478 passing through the second conditional switch 480 to the corresponding reference signal Va 312, Vb 314, Vc 316 to generate a corresponding control signal PWM A 382, PWM B 384, PWM C 386. Each control signal PWM A-C corresponds to a pair of control signals S shown in FIGS. 3A and 3B. For instance, control signal PWM A 382 corresponds to the first and fourth control signal S1, S4 such that the control signal PWM A 382 controls the first switch T1 and the fourth switch T4, and thus, controls the voltage at the output node A. Control signal PWM B 384 corresponds to the second and fifth control signals S2, S5 such that the control signal PWM B 384 controls the second switch T2 and the fifth switch T5, and thus, controls the voltage at the output node B. Control signal PWM C 386 corresponds to the third and sixth control signals S3, S6 such that the control signal PWM C 386 controls the third switch T3 and the sixth switch T5, and thus, controls the voltage at the output node C. Notably, each of the control signals PWM A-C include a respective clamping phase where the respective pair of switches T undergo clamping for one-third a period of the corresponding control signal PWM. Since the AC power signals provided by each of the output nodes A-C of the inverter are separated by one-hundred and twenty degrees (120-degrees) phase angle, the electronic controller 300 outputs control signals PWM A-C such that only one pair of switches T are controlled to undergo clamping for 60-degrees (i.e., one-third the period of time) phase angle while each of the other two pairs of switches T are controlled using PWM.

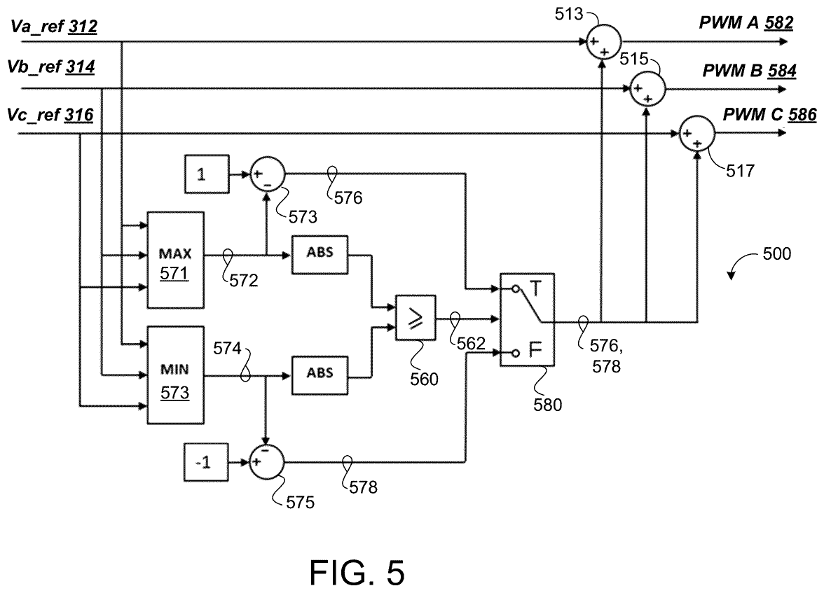

By contrast to the clamped space vector modulator 400 of FIG. 4 that uses the angle shift 322 for controlling the switch states, FIG. 5 shows a schematic view of another clamped space vector modulator 500 that does not use angle shift 322 for controlling switch states of the plurality of switches T1-T6. Similar to the clamped space vector modulator 400, a set of maximum and minimum operators 571, 573 are each configured to receive the reference voltages Va 312, Vb 314, Vc 316 (e.g., not conditioned on any angle shift 322) and output corresponding maximum and minimum values 572, 574. In some examples, a subtractor 573 subtracts the maximum value 572 from one (1) to generate a first output value 576 and another subtractor 575 subtracts the minimum value 574 from negative one (−1) to generate a second output value 578.

The clamped space vector modulator 500 compares absolute values of the maximum and minimum values 572, 574 at a first conditional switch 560. The first conditional switch 560 is configured to output a value 562 equal to “true” when the absolute maximum value 572 and the absolute minimum value 574 are greater than or equal to one. Conversely, the first conditional switch 560 is configured to output the value 562 equal to “false” when the absolute maximum value 572 and the absolute minimum value 574 are less than one. A second conditional switch 580 is configured to receive the value 562 from the first conditional switch 560 and output either the first output value 576 when the value 562 is equal to “true” or the second output value 578 when the value is equal to “false”. Thus, by contrast to the clamped space vector modulator 400 of FIG. 4 where the second conditional switch 480 is controlled based on the absolute maximum and minimum values 572, 574 conditioned on the angle shift 322, the second condition switch 580 of the clamped space vector modulator 500 is controlled based on the absolute maximum and minimum values 572, 574 not conditioned on any angle shift 322 determination. A corresponding adder 513, 515, 517 associated with each reference signal Va 312, Vb 314, Vc 316 then adds the first output value 576 or the second output value 578 passing through the second conditional switch 480 to the corresponding reference signal Va 312, Vb 314, Vc 316 to generate a corresponding control signal PWM A 582, PWM B 584, PWM C 586.

Notably, the clamped space vector modulator 500 of FIG. 5 that does not incorporate angle shift 322, calculates clamping periods for DPWM arbitrarily based solely on the voltage measurements Vd, Vq of the rotor angle of the electric motor 120, and by contrast to the clamped space vector modulator 400 of FIG. 4 that incorporates angle shift 322 based on the system state information 302 (FIG. 3A) and/or the current measurements id, iq (FIG. 3B) of the electric motor, inherently has no ability to minimize switching losses imposed on the inverter 200 while performing DPWM. That is, the use of the angle shift 322 employed by the clamped space vector modulator 400 of FIG. 4 provides the controller 300 with the ability to control the three-phase inverter 200 to opportunistically perform DPWM by calculating optimal times for clamping each phase of the inverter to minimize switching losses.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

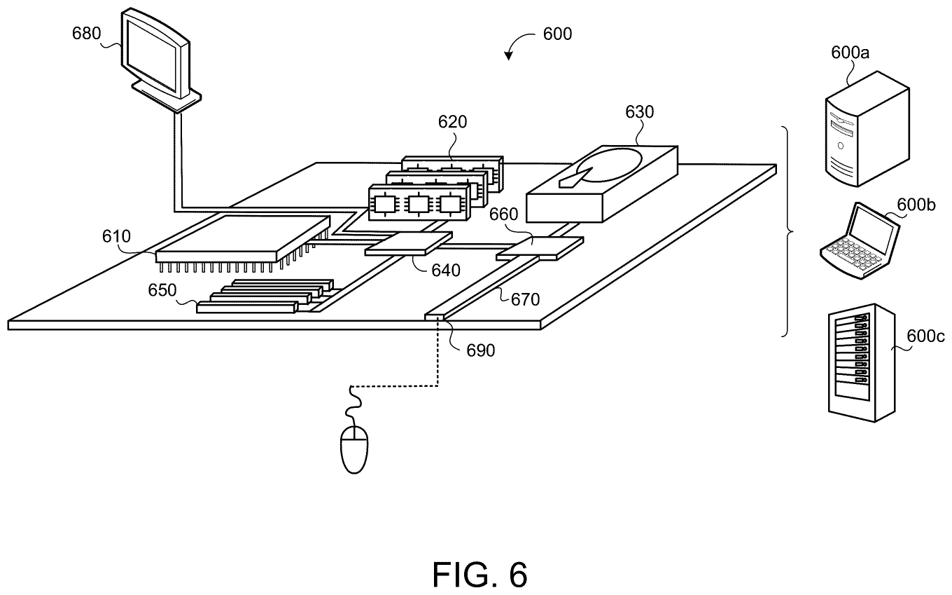

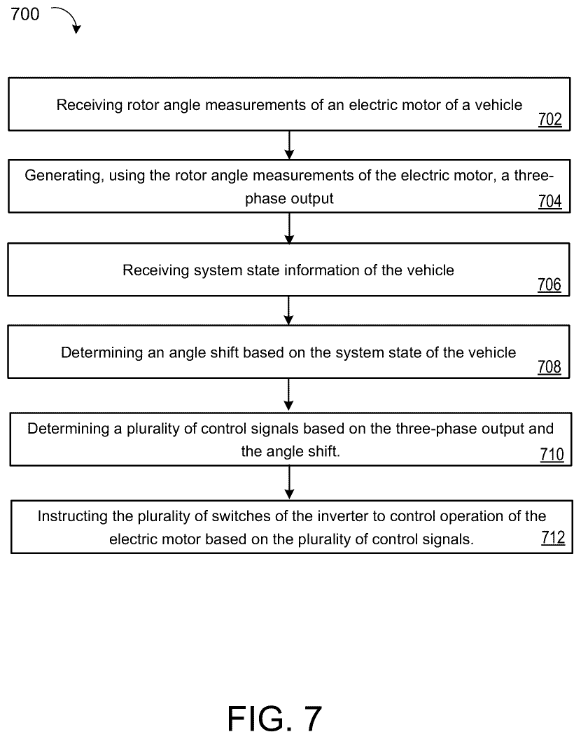

FIG. 6 is schematic view of an example computing device 600 employed by the vehicle 100 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The based on instructions stored on the memory hardware 620 processor 610 can process instructions for execution within the computing device 600, including instructions stored on the memory hardware (e.g., in the memory 620 or on the storage device 630) to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

FIG. 7 includes a flowchart of an example arrangement of operations for a method 700 of reducing switching losses of a plurality of switches of an inverter while performing discontinuous pulse width modulation (DPWM). The operations may execute on the data processing hardware 610 based on instructions stored on the memory hardware 620 of the vehicle. In some implementations, the controller 300 of the inverter 200 that executes on the data processing hardware 610 performs the operations. Optionally, another controller of the vehicle 100 executing on the data processing hardware 610 may perform the operations.

At operation 702, the method 700 includes receiving rotor angle measurements Vd, Vq of an electric motor 120. The electric motor 120 is implemented on the vehicle 100. At operation 704, the method 700 includes generating, using the rotor angle measurements Vd, Vq of the electric motor 120, a three-phase output 312, 314, 316. Here, the transformation module 310 may transform the rotor angle measurements into the three-phase output 312, 314, 316.

At operation 706, the method 700 includes receiving system state information 302 of the vehicle 100. The system state information 302 may include at least one of torque request (e.g., acceleration request), brake request (e.g., deceleration request), mass of the electric vehicle (e.g., known a priori and stored in the memory hardware 620), steering angle request (e.g., turning request), and/or a global positioning system (GPS) signal of the electric vehicle. The system state information 302 may additionally or alternatively include current measurements Id, Iq of the electric motor 120 during operation thereof.

At operation 708, the method 700 includes determining an angle shift 322 based on the system state information 302 of the vehicle 100, and at operation 710, the method 700 includes determining a plurality of control signals 372, 384, 386 based on the three-phase output 312, 314, 316 and the angle shift 322. Here, each respective control signal S1-S6 (also denoted by 382, 384, 386) of the plurality of control signals corresponds to a respective switch T1-T6 among a plurality of switches T of the inverter 200. At operation 712, the method 700 includes instructing the plurality of switches T1-T6 of the inverter 200 to control operation of the electric motor 120 based on the plurality of controls signals S1-S6.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed by data processing hardware causes that causes the data processing hardware to perform operations comprising:
receiving rotor angle measurements of an electric motor, the electric motor implemented on a vehicle;
generating, using the rotor angle measurements of the electric motor, a three-phase output;
receiving system state information of the vehicle;
determining an angle shift based on the system state information of the vehicle;
determining a plurality of control signals based on the three-phase output and the angle shift, each respective control signal of the plurality of control signals corresponding to a respective switch among a plurality of switches of an inverter; and
instructing the plurality of switches of the inverter to control operation of the electric motor based on the plurality of controls signals.

2. The computer-implemented method of claim 1, wherein instructing the plurality of switches of the inverter to control operation of the electric motor based on the plurality of controls signals comprises instructing two of the plurality of switches to clamp to a direct current voltage input for a period of time.

3. The computer-implemented method of claim 2, wherein a first one of the two of the plurality of switches instructed to clamp to the direct current voltage clamps to one of a positive terminal or a negative terminal for a first half of the period of time and clamps to the other one of the positive terminal or the negative terminal for a second half of the period of time.

4. The computer-implemented method of claim 3, wherein a second one of the two of the plurality of switches instructed to clamp to the direct current voltage clamps to the positive terminal when the first one of the two of the plurality of switches is clamping to the negative terminal and clamps to the negative terminal when the first one of the two of the plurality of switches is clamping to the positive terminal.

5. The computer-implemented method of claim 2, wherein instructing the plurality of switches of the inverter to control operation of the electric motor based on the plurality of controls signals comprises instructing other switches of the plurality of switches to modulate based on a pulse width modulation (PWM) signal while the two of the plurality of switches are instructed to clamp to the direct current voltage input for the period of time.

6. The computer-implemented method of claim 1, wherein the plurality of switches comprises:
a first pair of switches corresponding to a first output node of the inverter;
a second pair of switches corresponding to a second output node of the inverter; and
a third pair of switches corresponding to a third output node of the inverter.

7. The computer-implemented method of claim 1, wherein each switch of the plurality of switches comprises a metal-oxide-semiconductor field-effect transistor (MOSFET).

8. The computer-implemented method of claim 1, wherein each switch of the plurality of switches comprises an insulate-gate bipolar transistor (IGBT).

9. The computer-implemented method of claim 1, wherein the system state information of the electric vehicle comprises at least one of:
a torque request;
a brake request;
a mass of the electric vehicle;
a steering angle request; or
a global positioning system (GPS) signal of the electric vehicle.

10. The computer-implemented method of claim 1, wherein the operations further comprise:
receiving current measurements of the electric motor,
wherein the system state information comprises the current measurements of the electric motor.

11. A vehicle comprising:
an electric motor;
an inverter;
data processing hardware; and
memory hardware in communication with the data processing hardware and storing instructions that when executed on the data processing hardware cause the data processing hardware to perform operations comprising:
receiving rotor angle measurements of the electric motor;
generating, using the rotor angle measurements of the electric motor, a three-phase output;
receiving system state information of the vehicle;
determining an angle shift based on the system state information of the vehicle;
determining a plurality of control signals based on the three-phase output and the angle shift, each respective control signal of the plurality of control signals corresponding to a respective switch among a plurality of switches of the inverter; and
instructing the plurality of switches of the inverter to control operation of the electric motor based on the plurality of controls signals.

12. The vehicle of claim 11, wherein instructing the plurality of switches of the inverter to control operation of the electric motor based on the plurality of controls signals comprises instructing two of the plurality of switches to clamp to a direct current voltage input for a period of time.

13. The vehicle of claim 12, wherein a first one of the two of the plurality of switches instructed to clamp to the direct current voltage clamps to one of a positive terminal or a negative terminal for a first half of the period of time and clamps to the other one of the positive terminal or the negative terminal for a second half of the period of time.

14. The vehicle of claim 13, wherein a second one of the two of the plurality of switches instructed to clamp to the direct current voltage clamps to the positive terminal when the first one of the two of the plurality of switches is clamping to the negative terminal and clamps to the negative terminal when the first one of the two of the plurality of switches is clamping to the positive terminal.

15. The vehicle of claim 12, wherein instructing the plurality of switches of the inverter to control operation of the electric motor based on the plurality of controls signals comprises instructing other switches of the plurality of switches to modulate based on a pulse width modulation (PWM) signal while the two of the plurality of switches are instructed to clamp to the direct current voltage input for the period of time.

16. The vehicle of claim 11, wherein the plurality of switches comprises:
a first pair of switches corresponding to a first output node of the inverter;
a second pair of switches corresponding to a second output node of the inverter; and
a third pair of switches corresponding to a third output node of the inverter.

17. The vehicle of claim 11, wherein each switch of the plurality of switches comprises a metal-oxide-semiconductor field-effect transistor (MOSFET).

18. The vehicle of claim 11, wherein each switch of the plurality of switches comprises an insulate-gate bipolar transistor (IGBT).

19. The vehicle of claim 11, wherein the system state information of the electric vehicle comprises at least one of:
a torque request;
a brake request;
a mass of the electric vehicle;
a steering angle request; or
a global positioning system (GPS) signal of the electric vehicle.

20. The vehicle of claim 11, wherein the operations further comprise:
receiving current measurements of the electric motor,
wherein the system state information comprises the current measurements of the electric motor.
